(19) United States
(12) Patent Application Publication
(10) Pub. No.: US 2008/0096103 A1
(43) Pub. Date: Apr. 24, 2008

(54) Separator for lithium polymer batteries and method for the production thereof

(75) Inventor: Herbert Naarmann, Frankenthal (DE)

Correspondence Address: DRINKER BIDDLE & REATH;ATTN: INTELLECTUAL PROPERTY GROUP, ONE LOGAN SQUARE, 18TH AND CHERRY STREETS, PHILADELPHIA, PA, 19103-6996, US

(73) Assignee: Dilo Trading AG, Zug (CH)

(21) Appl. No.: 11/975,830

(22) Filed: Oct. 22, 2007

(30) Foreign Application Priority Data
Oct. 21, 2006 (DE) 10 2006 049 746.5

(51) Int. Cl. H01M 2/16; B05D 1/00; D03D 1/00; D03D 15/00

(52) U.S. Cl. 429/122; 139/420 C; 427/58; 428/221; 428/304.4; 428/332

(57) ABSTRACT

Separators for lithium-polymer batteries and methods for their production are described. One separator has the capability of preventing meltdown and short-circuit in the event of overheating an overvoltage. One separator is a dual-component fabric based on glass fibers and polymer fibers and comprises micropores for impregnation. One such fabric has a thickness of 2 through 15 μm and is used as an intermediate layer between anode and cathode; applications of absorber additives such as magnesium oxide or magnesium carbonate improve the effectiveness of the separator.

### CROSS REFERENCE TO RELATED APPLICATION

This application claims benefit of German Patent Application No. 10 2006 049746.5, filed Oct. 21, 2007.

### BACKGROUND

The present invention relates to a separator for lithium polymer batteries and a method for its production, the separator having the capability of preventing meltdown and short-circuit in the event of overheating and overvoltage.

The separator is a dual-component fabric based on glass fibers and polymer fibers and comprises micropores for impregnation with an electrolyte.

Various separator types are described in the Handbook of Battery Materials edit. I. O. Besenhard, Wiley-VCH Verlag [1999] by W. Böhnstedt, p. 245-292 and R. Spotnite, p. 553-563, (“Lit. 1”) which is incorporated herein by reference in their entirety.

Membranes made of polypropylene, polyethylene, or combinations are cited as materials. Gel-electrolyte separators are a refinement or a parallel development (Lit. 1, p. 557, PVDF/HFP (vinylidene-difluoride/hexafluoropropylene) polymers swollen in organic solvents are used here): however, the increase of the electrical internal resistance by fivefold, for example, is disadvantageous here (Lit. 1, p. 557 [25]).

Other measures comprise the combination of gel layers with microporous membranes (Lit. 1, p. 557 [29], [30]) e.g., Celgard®.

DE 199 16 043 describes composite bodies, comprising:

Aa) at least one separator layer Aa, which has a mixture Ia, containing a mixture Iia, comprising

a. 1 to 95 wt.-% of a solid IIl, preferably a basic solid III, having a primary particle size of 5 nm to 20 μm, and

b. 5 to 99 wt.-% of the polymer compound IV, obtainable by polymerization of

bi. 5 to 100 wt.-%, in relation to the compound IV, of a condensation product V made of

α. at least one compound VI, which is capable of reacting with a carboxylic acid or a sulfonic acid or a derivative or a mixture made of two or more thereof, and

β. at least 1 mole per mole of the compound VI of a carboxylic or sulfonic acid VII, which has at least one radically polymerizable functional group, or a derivative thereof or a mixture made of two or more thereof, and

b2. 0 to 95 wt.-%, in relation to the compound IV, of a further compound VIII having a mean molecular weight (numeric mean) of at least 5000 having polyether segments in the main or side chain, the weight proportion of the mixture Iia to the mixture la being 1 to 100 wt.-%,

i.e., the separator system described comprises a combination of a solid with a polymer and further additives.

DE 100 41 630 A1 also describes a solid electrolyte separator for a high-temperature cell, which is sintered after adding binder.

DE 199 14 272 A1 describes a separator based on aluminum oxide, having other oxides such as sodium, lithium, and/or magnesium oxide, and a thermoplastic binder.

WO 01/82403 A1 describes the production of a polymer electrolyte separator based on copolymers of vinylidene and hexafluoropropylene with fillers by extrusion. In all known cases, combinations of ceramic compound with polymer binders are used; the polymers sometimes being provided prefinished as microporous membranes (Lit. 1).

One goal of certain embodiments of the present invention is to present, with the novel separator, a simpler method, in regard to a continuous process, having lower energy and processing costs, as well as environmentally-careful conditions, and to improve the safety conditions for the lithium polymer batteries parallel thereto (cf. Lit. 3, Lithium Ion Batteries edit. M. Wakihara, O. Yamamoto, Wiley VCH Verlag, New York, 1998, p. 83, 4.3 Safety, which is incorporated herein by reference in its entirety), in regard to overcharging, short-circuit, and “nail penetration test”.

### SUMMARY

According to an embodiment of the present invention, there is provided a separator for lithium-polymer cells, comprising a fabric made of glass fibers and polymer fibers, wherein the glass fibers are situated transversely to the polymer fibers in the fabric. A cell may then be formed by placing the separator between an anode and a cathode.

According to an embodiment of the present invention, there is provided a lithium-polymer cell comprising an anode, a cathode, and a separator comprising a fabric made of glass fibers and polymer fibers between the anode and the cathode. The glass fibers may then be situated transversely to the polymer fibers in the fabric.

According to another embodiment of the invention, there is provided a method for producing separators for lithium-polymer cells, comprising weaving a fabric from glass fibers in one direction and polymer fibers in a direction transverse to the one direction. A cell may then be formed by placing the separator between an anode and a cathode.

According to a further embodiment of the invention, there is provided a method of manufacturing a lithium-polymer cell, comprising producing a separator by weaving a fabric from glass fibers and polymer fibers, and placing the separator as an intermediate layer between extruded electrode compounds. The method may comprise weaving the fabric from glass fibers in one direction and polymer fibers in a direction transverse to the one direction.

The polymer fibers may comprise organic synthetic polymers, which may comprise fibers of at least one material selected from polyethylene, polypropylene, fluoropolymers, and mixtures thereof.

The fabric may have a thickness of 2 to 15 μm and the fibers used may then be 0.1 to 5 μm thick.

The fabric may have coatings on one or both sides in thicknesses of 1-5 μm.

The surface coating of the separator may comprise magnesium oxide, at least one material selected from alkaline oxides, alkaline earth oxides, alkaline carbonates, and alkaline earth carbonates, and aprotic solvents, wherein the ratio of said oxides and carbonates to said solvent is 1:5 to 1:10. The surface coating of the separator may also comprise at least one conductive salt selected from lithium organyl borate and LiPF₆ in quantities 1:1, in relation to the inorganic solids.

The fabric may have a mesh width of 1 to 10 μm, preferably of 2-4 mm, and may have a porosity of 30-40%.

The separator may be used as an intermediate layer between extruded electrode compounds in the cell.

In a wound cell, the polymer fibers may extend in the circumferential direction of the winding and the glass fibers may extend in the axial direction.

The fabric may be woven with the polymer fibers in the run direction.

According to an embodiment of the present invention, glass fibers are processed with polymer fibers to form specific defined fabrics.

The fibers used for the separator according to an embodiment of the present invention, made of glass or synthetic organic polymers, may have diameters of 0.1 to 5 μm, preferably from 0.5 to 2 μm.

The thickness of the fabric according to an embodiment of the present invention is 2 to 15 μm, preferably 3 to 8 μm. The fibers used need not contain any layers or other surface coatings. The polymer fibers may be produced from organic synthetic polymers, preferably polyolefins such as polyethylene or polypropylene; fluoropolymers, homopolymers, copolymers, or terpolymers based on tetrafluoroethylene, hexafluoropropylene, vinylidene fluoride, or vinyl perfluoroalkoxyethers are also suitable. The fabrics obtained according to the present invention are suitable as separators for lithium polymer batteries. They are porous and may have mesh widths according to DIN 4189 and DIN 4197 of 0.1-10 μm, preferably of 2-4 μm and porosities of 30 to 50%.

The fabrics are suitable for use as separators; they may still be improved by adding absorbents such as magnesium oxide, magnesium carbonate, or the corresponding calcium derivatives or additives such as cement. These additives may be applied by admixing with aprotic solvents such as dimethoxyethane (DME), alkyl carbonates such as diethyl carbonate (DEC), diisopropyl carbonate (DPC), ethylene carbonate (EC), propylene carbonate (PC) or perfluorobutyl methyl ether (PFE), methoxinone fluorobutane (MFB), ethoxinone fluorobutane (EFB), or other solvents.

The mixing ratio of solid to solvent may be 1 to 5 through 10. The mixtures are then typically pastes and are used as thin layers having application thicknesses of 1 to 5 μm on the fabric. The application of the pastes (coating compounds) may be performed continuously or discontinuously, expediently by squeegees. The coating on the fabric is performed on one or both sides, but preferably on only one side.

Conductive salts such as lithium organyl borate (lithium oxalate borate) or LiPF₆ are suitable as further additives (additive LS). These additives (additive LS) are used in the quantity 1:1, in relation to the inorganic solids.

The fabric according to the present invention is used—with or without coating—as separators for lithium-polymer wound or flat cells.

In wound cells, the winding or run direction of the fabric is the longitudinal direction of the polymer fibers, i.e., the glass fibers each lie transversely to the longitudinal or run direction of the winding. As typical, the separator is the middle layer (in a trilaminate) between anode and cathode.

The electrode compounds are expediently extruded and applied hot (80-120° C.) directly to the particular electrode diverter. (The anode may be unprimed copper film; the cathode may be aluminum film primed using Dyneon THV 220 D/carbon black 3:1). Anode and cathode may be assembled with the separator as the insulating intermediate layer and processed either to form a wound cell or flat cell as the trilaminate.

It is to be understood that both the foregoing general description and the following detailed description are exemplary and explanatory and are intended to provide further explanation of the invention as claimed.

### DETAILED DESCRIPTION

Reference will now be made in detail to various embodiments of the present invention, examples of which are illustrated in the accompanying drawings. The embodiments are described by way of explanation, and not by way of limitation.

According to the present embodiments, glass fibers are processed with polymer fibers to form specific defined fabrics, for use as separators in lithium-polymer cells. The glass fibers may be as discussed in Ullmann's Encyclopedia of Industrial Chemistry A12, 6.1.9, Verlag VCH, 1989, which is incorporated herein by reference in its entirety. The polymer fibers may be as discussed in Ullmann's Encyclopedia of Industrial Chemistry A10, p. 511-655, Verlag VCH, 1987, which is incorporated herein by reference in its entirety.

The fibers used for the separator according to the present embodiment, made of glass or synthetic organic polymers, may have diameters of 0.1 to 5 μm, preferably from 0.5 to 2 μm.

In the embodiment, the above-mentioned fibers are woven into a fabric according to typical weaving technology—having warp and weft; the glass fibers each being woven perpendicular to the polymer fibers. The polymer fibers are woven in the weft direction of a loom, or the longitudinal or run direction of a continuous loom. The direction of the polymer fibers is the rolling direction of the woven fabric.

The thickness of the fabric in the embodiment is 2 to 15 μm, preferably 3 to 8 μm. The fibers used do not contain any layers or other surface coatings. The polymer fibers are produced from organic synthetic polymers, preferably polyolefins such as polyethylene or polypropylene; fluoropolymers, homopolymers, copolymers, or terpolymers based on tetrafluoroethylene, hexafluoropropylene, vinylidene fluoride, or vinyl perfluoroalkoxyethers are also suitable. The fabrics obtained are suitable as separators for lithium polymer batteries. They are porous and have mesh widths of 0.1-10 μm, preferably of 2-4 μm and porosities of 30 to 50% according to DIN 4189 and DIN 4197, as discussed in Ullmann's Encyclopedia of Industrial Chemistry Vol. B2, 15-19, VCH Verlag 1988, which is incorporated herein by reference in its entirety.

The fabrics are suitable for use as separators; they may still be improved by adding absorbents such as magnesium oxide, magnesium carbonate, or the corresponding calcium derivatives or additives such as cement. These additives are applied by admixing with aprotic solvents such as dimethoxyethane (DME), alkyl carbonates such as diethyl carbonate (DEC), diisopropyl carbonate (DPC), ethylene carbonate (EC), propylene carbonate (PC) or perfluorobutyl methyl ether (PFE), methoxinone fluorobutane (MFB), ethoxinone fluorobutane (EFB), or other solvents.

The mixing ratio of solid to solvent is 1 to 5 through 10. The mixtures are pastes and are used as thin layers having application thicknesses of 1 to 5 μm on the fabric. The application of the pastes (coating compounds) is performed continuously or discontinuously, expediently by squeegees. The coating on the fabric is performed on one or both sides, but preferably on only one side.

Conductive salts such as lithium organyl borate (lithium oxalate borate) or LiPF6 are suitable as further additives (additive LS). These additives (additive LS) are used in the quantity 1:1, in relation to the inorganic solids.

The fabric according to the present invention is used—with or without coating—as separators for lithium-polymer wound or flat cells.

In wound cells, the winding or run direction of the fabric is the longitudinal direction of the polymer fibers, i.e., the glass fibers each lie transversely to the longitudinal or run direction of the winding. As typical, the separator is the middle layer (in the trilaminate) between anode and cathode. The production of the electrodes (anode and cathode) is not the subject matter of the present invention, but it is to be noted, because the quality of the electrodes has a significant influence on the performance and the correct operation of the overall system.

The electrode compounds are expediently extruded and applied hot (80-120° C.) directly to the particular electrode diverter (anode-unprimed copper film, cathode-aluminum film primed using Dyneon THV 220 D/carbon black 3:1). Anode and cathode are assembled having the separator as the insulating intermediate layer and processed either to form a wound cell or flat cell as the trilaminate.

Housing the trilaminate in the particular cell body, poling, filling with electrolyte, degassing, shaping are typical work steps that may be carried out in any convenient manner, including manners already known in the art, and in the interests of conciseness are not further described in this application. Details about the method and use of the separator according to the present invention are discussed in the following examples.

### EXAMPLE 1

Use of the fabric according to an embodiment of the present invention

Glass fibers having a diameter of 3 μm were woven with polyethylene fibers having diameters of 2-4 μm to form a fabric. The fabrics may be as discussed, for example, in Makromoleküle [macromolecules] Vol. 2, p. 547, H. G. Elias, Hüthig u. Wepf Verlag, Basel 1992, which is incorporated herein by reference in its entirety. The sizing present on the fibers was washed off and the fabric was dried in the dry air stream at 60-70° C. before use. The fabric (“separator I”) had a thickness of 8-12 μm, a porosity of approximately 40%, and a mesh width of approximately 5 μm.

a. The fabric: separator I was used for the production of trilaminate for lithium-polymer cells without further additives.

b. The fabric produced according to Example 1: separator I was coated using a mixture of 50 wt.-parts Mg.CO₃, 10 wt.-parts lithium oxalate borate, and 40 wt.-parts dimethoxybutane by squeegee application on one side, the layer thickness was approximately 3-5 μm and resulted in the fabric “separator II.”

c. The fabric separator I produced according to Example 1 was coated using a mixture of 50 wt.-parts MgO and a solution of 10 wt.-parts LiPF6 and 40 wt.-parts ethoxyfluorobutane by squeegee application and on one side as in (b); the layer thickness was approximately 3-5 μm. The fabric thus modified is “separator III.”

d. The fabric separator I produced according to Example 1 was coated using a mixture of 50 wt.-parts cement (Portland standard type) and a solution of 10 wt.-parts LiPF₆ and 40 wt.-parts alkyl carbonate (20 parts ethylene carbonate and 20 parts diethyl carbonate) by squeegee application, on one side as above; the layer thickness was 3-5 μm. The fabric thus modified is “separator IV.”

### EXAMPLE 2

Production of a Varied Fabric Type

e. Corresponding to Example 1, polypropylene fibers(s) having diameters of 0.1 to 2 μm were used instead of polyethylene fibers. The corresponding fabric has a thickness of 6-10 μm; a porosity of 43%, and a mesh width of approximately 3 μm. The fabric was washed until free of sizing, dried in the air stream at approximately 60-80° C., and thus used for the cell construction as a separator layer in the trilaminate. The fabric had the identification “separator V.” For the fabric of separator type I according to Example 1, and also for the fabric according to Example 2 type separator V, the polymer fibers are situated in the run direction (i.e., processing and winding direction) and the glass fibers are provided perpendicular thereto, i.e., transversely to the fabric direction (i.e., to the organic polymer fiber direction).

f. Corresponding to 1d, the fabric according to Example 2 (separator V) was coated, the fabric thus modified is separator VI.

g. Corresponding to 1c, the fabric according to Example 2 (separator V) was coated on both sides. The layer thickness was 1-2 μm for each layer. The fabric thus modified is separator VII.

### EXAMPLE 3

Use of the fabrics (separators) as an intermediate layer in trilaminate for lithium-polymer battery cells.

The separators I-VII (a-g) were each used as the intermediate layer between anode and cathode and the resulting trilaminate made of anode/separator/cathode was processed further.

| a. | Separator | I | 35 mA/m² capacitance |
|---|---|---|---|
| b. | Separator | II | 36 |
| c. | Separator | III | 40 |
| d. | Separator | IV | 32 |
| e. | Separator | V | 39 |
| f. | Separator | VI | 40 |
| g. | Separator | VII | 30 |

Through subsequent lamination and winding, a trilaminate was provided which was housed, poled, and shaped according to the techniques typical in the field. MCMB® (OsakaGas) 91%, having 7% terpolymer Dyneon 220® (3M Comp.) and 2% lithium oxalate borate, coated on a 12 μm thick unprimed copper film was used as the anode, the layer thickness of the anode compound was 22-26 μm.

LiNiₓCo₁₋ₓO₂ (H. C. Starck) 89% having 7% terpolymer Dyneon 220® (3M Comp.) and 2% lithium oxalate borate, coated on an aluminum film primed using Dyneon THV 220D/carbon black was used as the cathode, its thickness was 25-30 μm.

Anode and cathode having the separator intermediate layer were shaped into a wound cell.

The following parameters were selected for the batteries and for comparison with a battery according to the comparative example.

| | |
|---|---|
| Capacitance: | *6 Ah |
| upper cut-off voltage: | 4.2 V |
| lower cut-off voltage: | 3.0 V |
| maximum current: | 6 A (corresponding to 1 C rate) |
| cycle test: | Charging and discharging was performed at a 1 C |
| | rate until the final capacitance is achieved 80%. |
| | The number of cycles until achieving 80% are |
| | the “achieved cycles” |
| pulse test: | 30-second cycle having 20 C load |

*battery testing device from Digatron (Aachen)

The capacitance is 30-40 mA/cm² and the carrying capacity at 4 C in the event of a fading <1.5%

nail penetration test (NP test): All batteries having separators I-VIII survived the NP test.

Comparison Battery

Anode and cathode corresponded to the Examples, but Celgard 3025® having 40% perforation and a thickness of 12 μm was used as the separator. These cells displayed a fading (at 80%) of approximately 3-4%.

The NP test was not survived, a short-circuit occurred.

Various modifications and variations can be made in the present invention without departing from the spirit or scope of the invention. Thus, it is intended that the present invention cover the modifications and variations of this invention provided they come within the scope of the appended claims and their equivalents.

What is claimed is:

1. A separator for lithium-polymer cells, comprising a fabric made of glass fibers and polymer fibers, wherein the glass fibers are situated transversely to the polymer fibers in the fabric.

2. The separator according to claim 1, wherein the polymer fibers comprise organic synthetic polymers.

3. The separator according to claim 1, wherein the fabric has a thickness of 2 to 15 μm and the fibers used are 0.1 to 5 μm thick.

4. The separator according to claim 1, wherein the fabric has coatings on one or both sides in thicknesses of 1-5 μm.

5. The separator according to claim 4, wherein the surface coating of the separator comprises magnesium oxide, at least one material selected from alkaline oxides, alkaline earth oxides, alkaline carbonates, and alkaline earth carbonates, and aprotic solvents, wherein the ratio of said oxides and carbonates to said solvent is 1:5 to 1:10.

6. The separator according to claim 4, wherein the surface coating of the separator also comprises at least one conductive salt selected from lithium organyl borate and LiPF₆ in quantities 1:1, in relation to the inorganic solids.

7. The separator according to claim 1, wherein the fabric has a mesh width of 1 to 10 μm, preferably of 2-4 mm, and a porosity of 30-40%.

8. A lithium-polymer cell comprising an anode, a cathode, and a separator according to claim 1 separating the anode and the cathode.

9. The cell according to claim 8, wherein the separator is used as an intermediate layer between extruded electrode compounds.

10. The cell according to claim 8, which is a wound cell, wherein the polymer fibers extend in the circumferential direction of the winding and the glass fibers extend in the axial direction.

11. A method for producing separators for lithium-polymer cells, comprising weaving a fabric from glass fibers in one direction and polymer fibers in a direction transverse to the one direction.

12. The method according to claim 11, further comprising weaving the fabric with the polymer fibers in the run direction.

13. The method according to claim 11, further comprising weaving the fabric 2 to 15 μm thick from fibers 0.1 to 5 μm thick.

14. The method according to claim 11, further comprising weaving the fabric with a mesh width of 1 to 10 μm, and a porosity of 30-40%.

15. The method according to claim 11, further comprising applying coatings in thicknesses of 1-5 μm to one or both sides of the fabric.

16. The method according to claim 15, wherein the surface coating comprises:
magnesium oxide;
at least one alkaline or alkaline earth oxide or alkaline or alkaline earth carbonate; and
at least one aprotic solvent; and
the ratio of said oxides and carbonates to said solvent is 1:5 to 1:10.

17. The method according to claim I 1, wherein the surface coating further comprises at least one conductive salt selected from lithium organyl borates and LiPF₆ in quantities 1:1 in relation to the inorganic solids.

18. A method of manufacturing a lithium-polymer cell, comprising:
producing a separator by the method according to claim 12; and
placing the separator as an intermediate layer between extruded electrode compounds.

19. A lithium-polymer cell, comprising:
an anode;
a cathode; and
a separator comprising a fabric made of glass fibers and polymer fibers between the anode and the cathode.

20. A method for producing a lithium-polymer cell, comprising:
weaving a fabric from glass fibers and polymer fibers; and
placing the fabric as a separator between an anode and a cathode.
